(19) United States
(12) Patent Application Publication
(10) Pub. No.: US 2009/0235356 A1
(43) Pub. Date: Sep. 17, 2009

(54) MULTI VIRTUAL EXPERT SYSTEM AND METHOD FOR NETWORK MANAGEMENT

(75) Inventors: Robert JENSEN, Fredericia (DK); Dennis THOMSEN, Marbella (ES)

Correspondence Address: PILLSBURY WINTHROP SHAW PITTMAN, LLP, P.O. BOX 10500, MCLEAN, VA, 22102, US

(73) Assignee: CLEAR BLUE SECURITY, LLC, Scottsdale, AZ (US)

(21) Appl. No.: 12/388,864

(22) Filed: Feb. 19, 2009

Related U.S. Application Data
(60) Provisional application No. 61/036,516, filed on Mar. 14, 2008.

(51) Int. Cl. G06F 21/00; G06N 5/04; G06F 17/20; G06F 3/048; G06F 7/06; G06F 17/30; G06F 15/16; G06F 12/08; G06N 5/02; G06F 15/18

(52) U.S. Cl. 726/23; 706/46; 706/11; 715/810; 707/2; 707/4; 709/202; 711/118; 706/52; 706/12; 711/E12.038; 711/E12.017; 707/E17.014; 707/E17.015; 707/E17.032

(57) ABSTRACT

A system and method of determining an answer in an expert system having an inference engine and a knowledge database includes transmitting a query or sub-queries to a plurality of sub-expert systems, each comprising an associated inference engine and an associated knowledge database; receiving a sub-answer from each sub-expert system which has been inferred by the inference engine based upon knowledge in the knowledge database; transmitting the sub-answers to the expert system using the inference engine thereof to infer an answer to the query based upon knowledge in the knowledge database and the sub-answers received from the sub-expert systems; and transmitting the answer. A system for managing data includes a computer interface with a database arrangement that stores domain-related information, and which communicates with an inference engine that infers query results based upon the domain-related information and partial answers obtained from knowledge databases.

### CROSS REFERENCE TO RELATED APPLICATIONS

This application claims benefit under 35 USC 119(e) to U.S. provisional application Ser. No. 61/036,516, filed Mar. 14, 2008, and is related to U.S. application Ser. No. 11/960,970 (“Network Discovery System”) and U.S. Ser. No. 11/961,021 (“Agent Management System”) both filed on Dec. 20, 2007. The entire contents of each of these applications are incorporated herein by reference.

### BACKGROUND

Within the field of logical programming, it is possible to generate databases over data and knowledge and extract enhanced data using queries. When the amount of data increases, the processing increases and thus degrades the feasibility of such a solution. Similarly, the collection of data itself may produce a huge amount of data, which introduces a bottleneck.

### SUMMARY

In its broadest conceptual terms, the system and method of this disclosure represent a model and framework in which human expertise, implemented by a set of rules, for example, is decomposed into distinct smaller units called “virtual experts.” The virtual experts may easily be built and, in appropriate circumstances, distributed over a network. These virtual experts may be configured to work together to recommend a course of action or solution regarding a specific class of problem, for example security or performance assessment in a computer network or domain, or medical diagnoses, such as sleep disorders. The virtual experts may be supplemented by “virtual assistants”, which may be configured to collect information from a particular type of environment (e.g., computer network, medical, financial, etc.), and which may react to advice and/or instruction from the virtual experts on how to manage and control the environment. The multi-virtual experts system and method of this disclosure are well-suited to replace or substitute expert tasks that depend on human expertise and collaboration between experts across different classes of problems (domains), and which uniquely approach matching human intelligence, behavior, and communication patterns in certain tasks such as expert assessment, expert advice, pattern recognition, and diagnoses.

In one or more embodiments, a problem of discovering and analyzing dynamic data may be solved by a method and system using multiple virtual experts and a reconciling agent or process.

Among other things, this disclosure provides embodiments of expert systems and methods in which answers to various questions pertinent to a particular domain may be inferred by reconciling answers provided by a collection of sub experts having expertise in different areas related to the particular domain. The types of domains may include, but are not limited to medical information, transportation, computer network management, project management, or construction, for example. In other embodiments, this disclosure is directed to an expert system and method useful in computer network management, for example, a large-scale distributed computer network with multiple nodes and interconnected elements.

One or more aspects of this disclosure are directed to a system and method for discovering, collecting, transforming, and drawing inferences from data in a system. In one embodiment, this application is directed to a system and method with built-in hierarchical caching of answers related to data that enables enhanced quality of the answer and the speed with which an answer is presented in a highly dynamic environment including, but not limited to computer network environments, thus allowing the system to quickly respond and answer complex questions.

In one embodiment, a method of determining an answer to a query includes transmitting a query or a series of sub-queries relating thereto to a plurality of sub-expert systems, each sub-expert system comprising an associated inference engine and an associated knowledge database; receiving, with an expert system comprising an inference engine and a knowledge database, a sub-answer to the query or sub-query from each sub-expert system which has been inferred by the inference engine thereof based upon knowledge in the associated knowledge database thereof, with the expert system, using the inference engine thereof to infer an answer to the query based upon knowledge in the associated knowledge database and the sub-answers received from the sub-expert systems; and transmitting the answer.

In another embodiment of this disclosure, an arrangement of components includes an interface through which a domain-related question is communicated to an expert component having expertise in the domain; plural sub-experts in communication with the expert component, said one or more sub-experts each having expertise in different aspects of the domain; one or more data storage elements, wherein each of the data storage elements are interfaced with at least one of the plural sub-experts, wherein the plural sub-experts are configured to use knowledge contained in said one or more data storage components to answer one or more subquestions pertaining to the domain-related question, wherein the expert component is configured to evaluate the answers to the one or more subquestions and to answer the domain-related question.

In another embodiment of this disclosure, a computer-implemented multi virtual expert system having expertise in a domain includes a user interface; an expert manager configured to receive a user question related to the domain via the user interface and to identify one or more subquestions relating to the user question; a plurality of experts each capable of receiving and evaluating an answer to at least one of the one or more subquestions and reporting the answer to the expert manager; wherein the expert manager evaluates answers to the subquestions and reconciles any inconsistencies between the answers to the subquestions to form the answer to the user question.

In another embodiment of this disclosure, a method for determining an answer to a query includes inferring a pre-formulated answer to each of a plurality of pre-defined queries using an expert system comprising an inference engine and a knowledge database, the expert system being coupled to a network comprising network nodes and data elements relating to the nodes, wherein the inference engine infers each answer based on knowledge in the knowledge database and one or more data elements relating to the associated queries; storing the pre-formulated answers in a memory; receiving, from a user, a request to provide an answer to one of the pre-defined queries; checking a data freshness parameter for at least one of the data elements relating to the requested query; and, if each checked data freshness parameter is acceptable, providing the pre-formulated answer in the memory to the user in response to the request; if any checked data freshness parameter is unacceptable, then inferring a new answer to the requested query using the expert system, wherein the new answer is based on the knowledge in the knowledge database and the one or more data elements relating to the requested query; and providing the new answer to the user in response to the request.

In an embodiment of this disclosure, a computer-implemented method of using expert knowledge to provide an answer to a question related to a domain includes posing the question to a panel of experts; decomposing the question into a plurality of subquestions related to various aspects of the domain; answering each of the subquestions with a partial answer obtained from one or more relevant experts having access to one or more associated knowledge databases; evaluating each of the partial answers; reconciling any inconsistencies or ambiguity between any of the partial answers; and inferring the answer based upon said reconciling.

In another embodiment of this disclosure, an article of manufacture includes a machine-readable medium containing computer-executable instructions. When executed by a processor, the instructions may cause an expert system to be installed in the processor. The expert system may be configured to carry various functions including receiving a question asked from a list of predefined questions; decomposing the question into subquestions; determining data necessary to answer one or more of the subquestions; using the necessary data to answer the subquestions and to obtain one or more partial results; reconciling any inconsistencies between the one or more partial results; and inferring an answer to the question based upon said reconciling.

### BRIEF DESCRIPTION OF THE DRAWINGS

FIG. 1 provides an illustration of system 100 for answering questions;

FIG. 2 illustrates network of components 200;

FIG. 3 provides an exemplary flowchart illustrating logic 300 in a virtual expert system;

FIG. 4 illustrates a high level visualization of a multi virtual agent system 400 of an embodiment;

FIG. 5A provides a block diagram of an expert system embodiment 500 of this disclosure;

FIG. 5B provides a block diagram of workstation 520 depicted in FIG. 5A;

FIG. 6A provides a flowchart useful in the exemplary virtual expert system 600 of FIG. 6B to identify a performance problem in a computer network;

FIGS. 7A, 7B, and 7C continue the exemplary flowchart of FIG. 6A; and

FIGS. 8A, 8B, 8C, 9A, 9B, 9C, and 10 continue the exemplary flowcharts of FIGS. 6A and 7A-7C.

### DETAILED DESCRIPTION

The articles “a” and “an” as used in this disclosure and appended claims are to be construed in their broadest sense, i.e., these words are not to be limited to mean the recitation of a single element unless specifically limited to only one, but rather may also be construed to mean “at least one” or “one or more.”

Various functions and aspects of embodiments of this disclosure may be implemented in hardware, software, or a combination of both, and may include multiple processors. A processor is understood to be a device and/or set of machine-readable instructions for performing various tasks. A processor may include various combinations of hardware, firmware, and/or software. A processor acts upon stored and/or received information by computing, manipulating, analyzing, modifying, converting, or transmitting information for use by an executable procedure or an information device, and/or by routing the information to an output device. For example, a processor may use or include the capabilities of a controller or a microprocessor, or it may be implemented in a personal computer configuration, as a workstation, or in a server configuration.

Further, various conventionally known data storage and memory devices, for example, cache memory, may also be used in the computer-implemented system and method of this disclosure, as may conventional communications and network components. Network configurations may include wired local area network (LAN), wireless network topologies (WLAN), the internet, or a medical information bus (MIB), for example. These peripheral computer devices and network topologies are understood to be available and known to a person of ordinary skill in the art, and are not illustrated in the accompanying drawing figures so that the inventive concept may be more clearly understood.

Finally, discovery agents are known to be relatively small computer code segments which are installed to monitor and/or report various information relating to a component in which the agent is installed, for example, a network component or node.

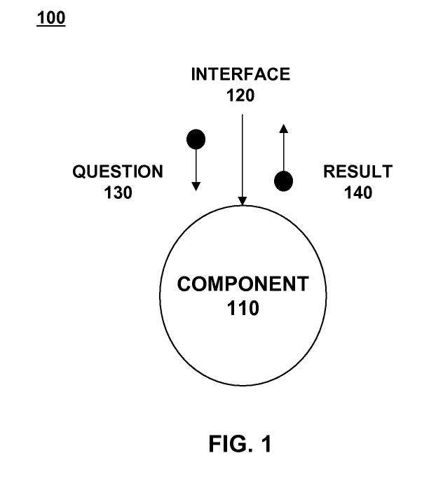

In the embodiment of FIG. 1, a high-level illustration is provided of expert system 100 for answering questions. Expert system 100 may include a number of components, for example, component 110. In this embodiment, component 110 has an interface 120 with, for example, a user, or another component or system (not shown). Interface 120 includes functionality that allows question 130 and answer or result 140 to be passed across interface 120 to/from component 110. Component 110 may contain a list of or generate various “subquestions” needed to answer question 130, if any. The subquestions are questions that may be answered by other components (not shown) and “decomposed” in a manner that is related to question 130. Component 110 may include a memory configured to store a list of predefined questions and answers, in which question 130 and result 140 may be included.

Examples of component 110 include, but are not limited to, virtual experts, a collection mechanism, and/or a data discovery agent. The components may be statically programmed, or they may involve a dynamic process, depending on the complexity of question 130 and/or subquestions pertaining to one or more questions 130.

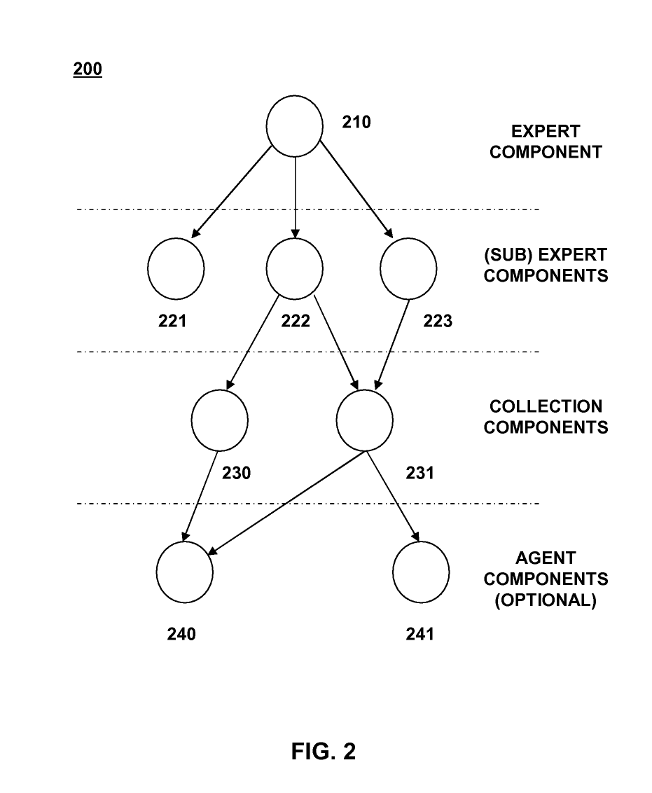

FIG. 2 illustrates another aspect of the above embodiment in which a network of components 200 is defined utilizing various types of components mentioned above. For example, expert component 210 is arranged in an “expert” abstraction layer, and is interfaced to sub expert components 221, 222, and 223 arranged in a “sub expert” abstraction layer. Various sub experts may use services of one or more collection components 230, 231 arranged in a collection abstraction layer. Some sub experts may not require specific data to be collected to answer subquestions. For example, sub expert 221 may merely rely upon static information for providing an answer to a subquestion or upon information provided by a user, and may not require that dynamic data be periodically refreshed to determine an appropriate answer.

In contrast, the nature of subquestions asked of sub expert components 222 and 223, for example, may make it desirable for an associated collection component 230 and 231 to periodically refresh data so as to update an associated answer stored in a cache memory (not shown). Collection components 230 and 231 may be interfaced with various agent components. For example, agents 240 and 241 may be arranged in a distributed “real world” manner associated with one or more distributed components. These distributed components may be, for example, a network node or component, or may include various medical devices such as a pulse/oximeter device, temperature probes, electroencephalogram (EEG), electrocardiogram (ECG), or other medical devices having electronic data output capability compatible with use of a MIB. Agents 240 and 241 may be configured to periodically monitor and update relevant information regarding their associated distributed components. Collection components 230, 231 may then collate and evaluate refreshed information received from agents 240, 241, and may, in one or more aspects of this embodiment, store refreshed answers in a cache memory, for example.

Sub experts 221, 222, and 223 may rely upon the refreshed data collected by collection components 230, 231 in order to provide the most up-to-date answers to various subquestions. In turn, expert component 210 relies upon the answers to the various subquestions to infer an answer to the question posed.

Caching of the sub results and scheduling a refreshing of answers to the questions and/or subquestions enables conditions in which a minimum amount of data is required to travel through the system, thus potentially reducing network traffic. Further, the complex questions asked at the top of the hierarchy (e.g., expert component 210) will “cross fertilize,” since various partial answers may be available for reuse in answering other questions. This parallel approach acts to optimize the amount of elapsed time it takes to obtain a result, since the refresh step can be done in parallel, and since some data that is not likely to change may not need to be refreshed and may already be stored in cache or other memory storage device.

In a networked system with thousand of components, the caching and scheduling system and method discussed above will allow improvement in response times over conventional approaches, since data may be collected once, forwarded once, and queried once per question asked of the expert system.

In further detail, network of components 200 includes an interface to an expert component 210 having expertise in a particular domain. A number of sub-experts 221, 222, 223 may be interfaced to expert component 210. Each of the sub-experts may have expertise in different aspects of the domain. One or more collection components 230, 231 may be interfaced with one or more sub-experts. An optional discovery agent or agents 240, 241 may be associated with a physical device or devices (not shown). The discovery agent or agents may be interfaced with one or more collection components. For example, agent component 240 is interfaced to provide data to collection components 230 and 231, while agent component 241 may only provide information to collection component 231. Further, expert component 210, and/or subexpert components 221, 222, 223 may be configured to reconcile potentially conflicting or ambiguous information discovered by the discovery agents 240, 241, and collected by components 230, 231. Ambiguities may be resolved at the lowest appropriate level, i.e., subexpert components 221, 222, 223 may resolve ambiguities in information provided by two or more collection components and/or agent components at a lower hierarchical level, and expert component 210 may resolve ambiguities in information provided by two or more subexpert components, if such ambiguities exist. In a related aspect, the discovery agents may follow particular data refresh schedules that enable acceptable data latency to be achieved for information stored relating to the physical devices, and which determine answers derived from the data. The term “data latency” is understood generally to mean a delay in the provision of data, but may also be construed to mean the relative degree of “freshness” or “staleness” of data, i.e., the amount of time that has lapsed since the data was revalidated or reacquired.

In another aspect of this embodiment, expert component 210 may be configured to provide responses, through the interface, to each of a number of predefined questions relating to a particular domain. By pre-defined, it is meant that the user is not crafting unique queries, but rather selects a query/question from a set that is defined in advance. Further, the interface may be configured to allow a user to select one of the predefined questions to be answered. Still further, at least one predefined question may include or be associated with a number of predefined sub-questions relating to the domain. To aid efficient and timely processing of information and to make use of potentially redundant information, answers to one or more of the predefined sub-questions may relate to two or more predefined questions.

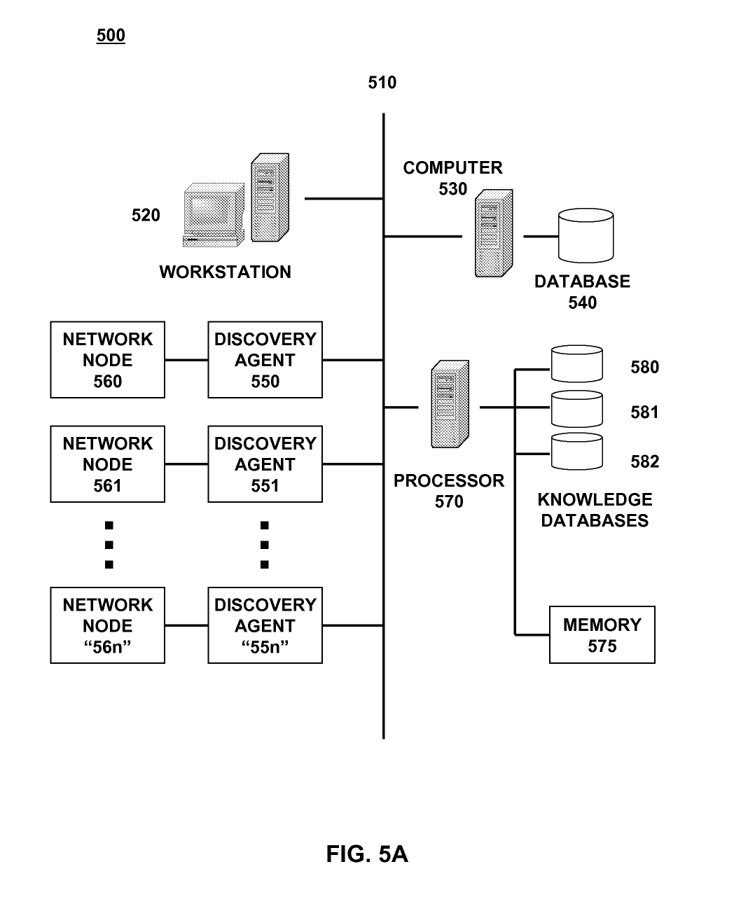

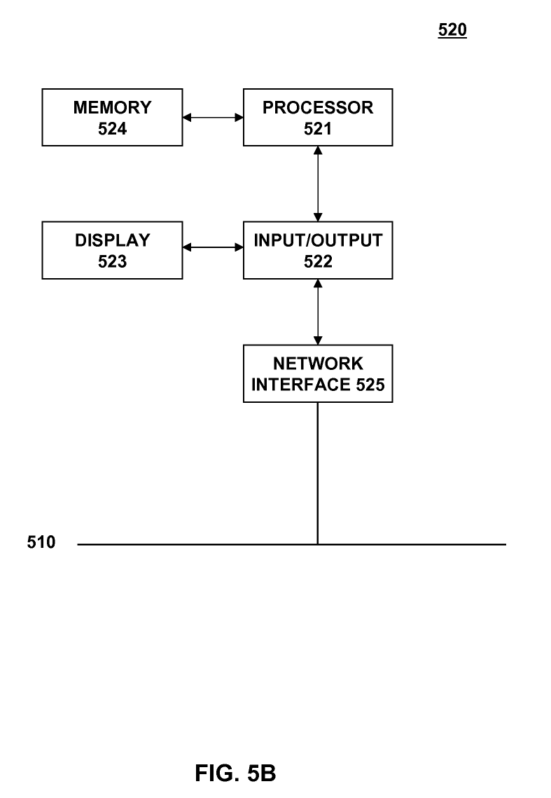

In another aspect of this embodiment, most recent answers to each of the plurality of predefined questions may be stored in a cache memory (not shown in FIG. 2, but see, e.g., memory 575 in FIG. 5A) that allows relatively quick access to and updating of stored information.

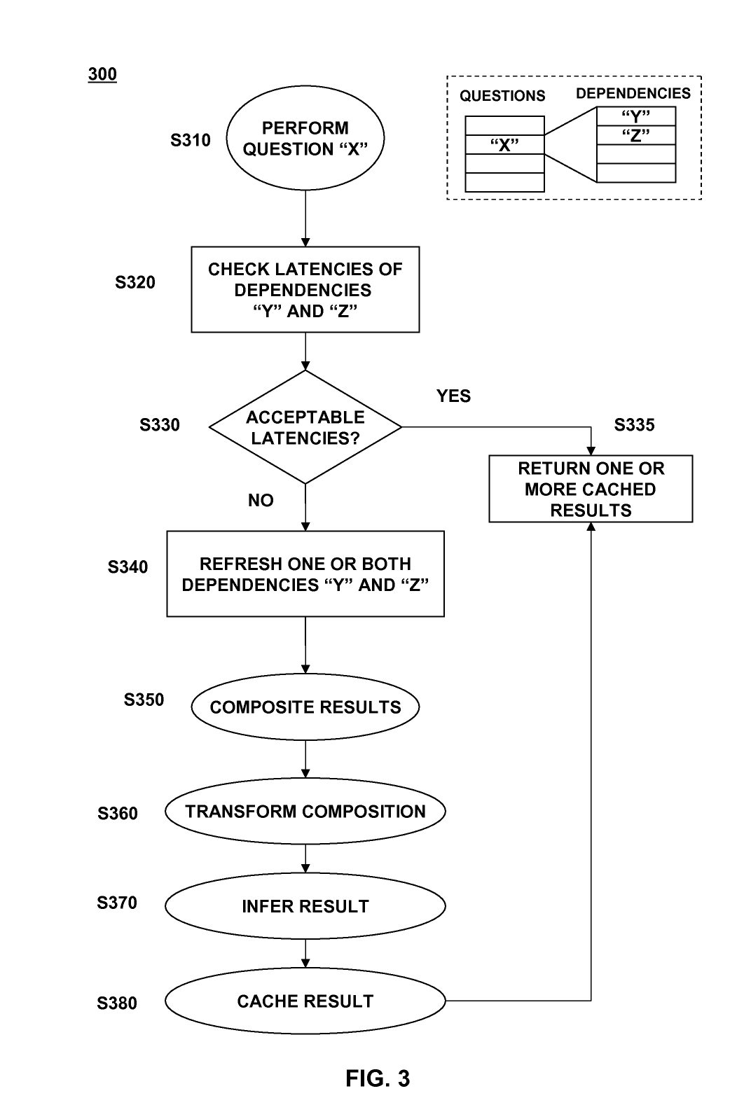

In FIG. 3, an exemplary flowchart of logic 300 is illustrated in which a virtual expert interacts with a relatively simple dependency-controlled cache mechanism. In step S310, an exemplary process to answer question “X” commences. Although not part of the flowchart, the dashed-line box in FIG. 3 illustrates that the universe of questions may include a predefined list of questions and related answers, of which question “X” is one. Further, various data dependencies may exist between the various predefined questions and the data relied on to answer the questions. For example, providing an answer to question “X” may use various data elements to determine the answer or sub answer. In FIG. 3, question “X” may depend on various data elements, of which dependencies “Y” and “Z” are illustrative.

At step S320, the latencies of dependencies “Y” and “Z” are checked. If each of the latencies of the data elements associated with dependencies “Y” and “Z” are acceptable in step S330, then a result (e.g., an answer or result determined by data associated with one or both of dependencies “Y” and “Z”) already in the cache is returned as a response/answer at step S335. This assumes that acceptably “fresh” data was used to infer the answer already stored in cache. If, however, one or both of the data latencies are unacceptable or if no answer is in cache, then one or both of the data elements associated with dependencies “Y” and “Z” are refreshed at step S340 so that a refreshed answer might be ascertained. Such refreshing may be accomplished, for example, by causing one or more discovery agents to provide updated information relating to data having the unacceptable data latencies.

Different criteria may determine the acceptability of latency for a data element. For example, a latency above a relatively small threshold may be unacceptable for a data element associated with a highly dynamic network component. Conversely, for a network component known to be relatively static, a higher threshold of latency or longer period of time before refreshing is required may be acceptable. Thus, the threshold levels for determining the latency acceptability for a given data element may vary based upon the type of component to which the data is related.

At step S350, the results or answers to one or more questions and/or subquestions may be placed into composite form, e.g., into a concatenated form. Further, at optional step S360, the composition may be transformed into a desired or appropriate format depending on the application and user preferences, for example.

At step S370, an optional inference component (in conjunction with an associated knowledge database, for example) may operate to infer a result that supplements or clarifies the previously obtained composite result. A collection mechanism could use a similar process flow without the “Infer Result” step.

The inferred answer or result is stored in cache (“cached”) at step S380, and this refreshed answer is then returned as the new or refreshed answer at step S335.

Questions can be scheduled to run at certain intervals to generated store pre-formulated results or answers. If the latency (i.e., “freshness”) of the data used to previously determine or infer the result/answer stored in cache is acceptable, then step S335 may return the previously cached result rather than cause new data to be collected and a new answer to be inferred from that new data. Likewise, if the freshness of the data underlying the answer is not acceptable, then the system may go through the process of collecting data and inferring a new “refreshed” answer, and storing the refreshed answer in cache.

Various data elements that may be used to determine various answers or sub-answers may be scheduled for automatic updates using different periodicities by discovery agents deployed throughout the system, for example. As mentioned above, the periodicity in which a particular answer is refreshed may be determined by the relative degree of dynamic behavior exhibited by a monitored network component which is used to determine the answer. The periodicity in which the answer is refreshed may be adjusted depending on the component behavior or changes in the network.

In addition, an agents' dependency list would not be a list of other components, but a list of local tools for discovering data relating to, for example, performance, availability of services etc. For example, the “Infer Result” step of FIG. 3 would not be applicable for agents since they are used merely to discover information.

Logic 300 in the flowchart of FIG. 3 may be implemented using an interpreted dynamic computer language, i.e., a script language such as “Ruby” and “Python”, for example, in order to achieve a process that has polymorphic behavior in regards to the question or questions asked. A question may require that requires a very specific set of data to be collected, and the process in FIG. 3 may, in such a scenario, be preceded by setting up an agent to collect the specific set of data.

In a related aspect of this embodiment, a computer-implemented method of managing a computer network includes receiving a question asked from a list of predefined questions. The predefined questions may be further decomposed into one or more related subquestions. A determination is made concerning the data necessary to answer the subquestions. Answers to the predefined questions and their associated subquestions may already be stored for easy retrieval and to reduce processing time when a question or subquestion is asked. Such storage may be in a cache memory, for example, in a manner as described above. Similarly, the cache may be checked for the necessary answer and, if a data latency associated with data necessary to answer the question is unacceptable, the answer in the cache may be refreshed by collecting the necessary data from one or more elements in the network and refreshing the answer in the cache by overwriting with be updated answer.

The newly “freshened” answer in the cache may be provided as an answer to a subquestion, and thereby obtain one or more partial results to the ultimate question as posed by one of the predefined questions. An answer may be inferred to the question from the partial results. Along with this, dependencies of the necessary data underlying the answer may be checked, and dependent data may be refreshed based at least on a data latency parameter of the necessary data. For example, and as previously mentioned, some network nodes or elements do not change their software and/or hardware configurations very frequently, while other network nodes or elements may be relatively dynamic in their functionality and/or configuration. Knowledge of the network topology may be useful in establishing the acceptable data latencies associated with each data element. Along these lines, data refresh operations for answers to predefined questions stored in the cache may be scheduled based, at least in part, upon a likelihood that a particular data element has changed.

Each partial result or answer to a subquestion may not necessarily be consistent with each other. Inferring an answer to the question from the one or more partial results may involve reconciling potentially conflicting or ambiguous partial results using an “super expert” or panel of experts, which may also be referred to as a reconciliation manager.

Furthermore, the list of predefined questions may relate to a particular domain other than network management, for example, the particular domain may relate to medical diagnostics including, for example, diagnosis of sleep disorders, in conjunction with the use of a particularized knowledge database or databases.

The predefined questions may also be provided through a computer interface to an expert system, for example. In a related aspect of this embodiment, information does not have to be collected by a collection agent, but information may also be obtained from a user, for example, through a user interface and provided to an inference engine that may use the information provided through the interface to at least partially answer one or more of the subquestions.

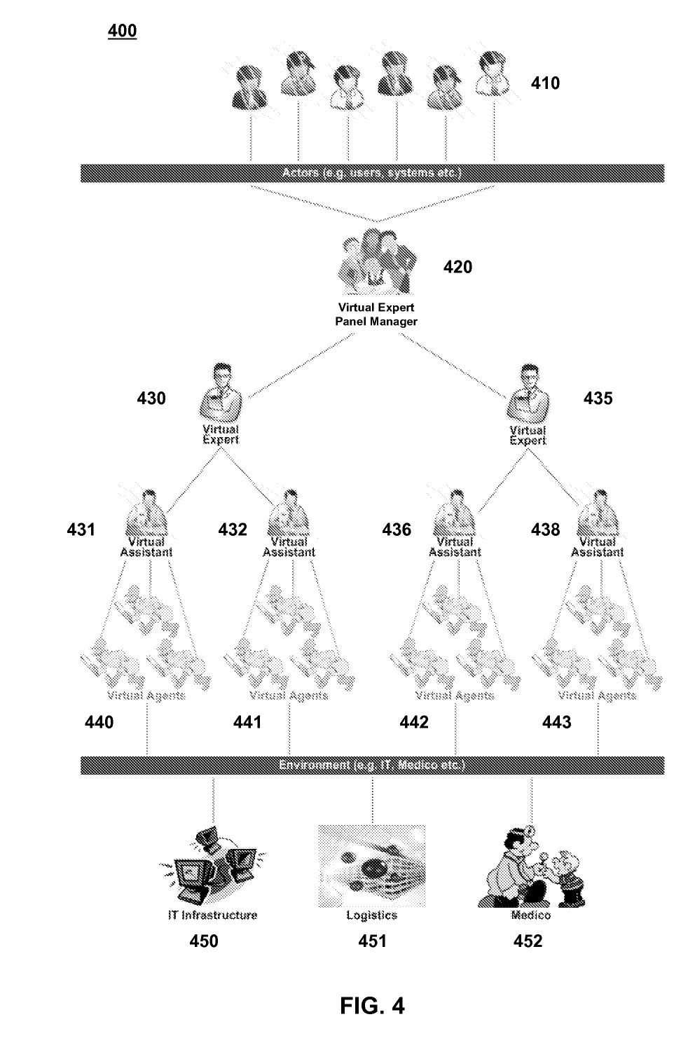

The embodiment of FIG. 4 is directed to a multi virtual expert system 400, wherein actors 410, e.g., users and/or systems, pose a question to virtual expert panel comprising a virtual expert panel manager 420 and a plurality of virtual experts 430, 435. Virtual expert panel manager 420, which may also be referred to as an upper-level expert system, may decompose the question asked by actors 410 into subquestions appropriate to the expertise of each virtual expert 430 and 435 within a domain (which may be referred to as a lower-level expert system(s) or sub-expert system). In some applications, it may be useful for virtual expert panel manager 420 to interact with actor(s) 410 via a computer interface, for example, by seeking refinement of the question, or establishing other relevant parameters related to the main question asked. Such questions may be uniquely crafted questions, or may be predefined questions.

“Predefined” questions may be questions that have been determined to be useful in answering various performance or technically-related questions that would routinely be asked, as discussed above with respect to FIG. 3. Other virtual experts may be utilized, as appropriate for the particular circumstance. Each predefined question may have a particular data dependency associated with it. A data latency requirement may be imposed on a particular piece of data based, at least in part, upon a likelihood of change of the data. In a computer network environment, for example, this may ultimately relate to the type of distributed component that is being monitored. Unique questions may also be added to the list of questions while being processed. After answering a unique question, it can be removed from the list. Alternatively, it could be handled by a specific mechanism implemented to perform this type of question only. Conceptually, you could have a predefined question that is unique in the sense that the input data, in fact, constitutes the unique question. The unique questions pertains only to expressibility; they will not benefit from the caching mechanism since they are “one-time” only.

Each virtual expert 430, 435 may answer a specific set of questions and may further decompose the subquestions into further subquestions, as deemed necessary. One or more virtual assistants 431, 432, 436, 438 may be associated therewith. Depending on the complexity (or nature) of the question, the virtual assistants may be configured to perform a set of tasks enabling an answer, or to cause various tasks to be performed to ascertain an answer, and then the virtual assistants may answer or infer an answer to the question.

Virtual expert panel manager 420, virtual experts 430, 435, and virtual assistants 431, 432, 436, 438 may employ various types of inference engines and particularized knowledge databases to assist in answering the various levels of questions and subquestions. In particular, each of the virtual expert panel manager 420 and the virtual experts 430, 435 may be an expert system with its Further, in some environments or domains, virtual assistants 431, 432, 436, 438 may optionally employ one or more virtual agents 440, 441, 442, 443 to collect data that might be necessary to answer one or more subquestions. These virtual agents may include known types of “discovery” or “collection” agents adapted to monitor and/or report on specific aspects of their environment, e.g., a change in a network node. In response to an evaluation of a data latency parameter, an associated collection agent may collect and store refreshed data. Still further, the collection agents may be configured to push changed data to a storage device. However, as mentioned above, the virtual expert panel manager 420 and/or virtual experts 430, 435 may answer a question or subquestion using data stored in the cache memory without the need for involvement of a collection agent.

The virtual assistants and virtual agents may be adapted to operate in various environments. For example, system 400 may be adapted to operate in an IT infrastructure 450, such as a computer network, or may be adapted to have expertise in a transportation or logistics environment 451, or may be adapted to provide various types of medical diagnoses in medical system 452, which may include a Medico, i.e., a licensed medical practitioner.

In whatever environment they may be adapted to operate, virtual agents 440-443 may collect data either automatically or by manual means including human interaction, and provide the collected data to the associated virtual assistant 431, 432, 436, 438. The virtual assistant(s) may collate and/or evaluate the data provided by the virtual agent(s) before providing an answer to one or more subquestions to the associated virtual expert 430 or 435. Virtual expert panel manager 420 may then evaluate the various answers to subquestions provided by virtual experts 430, 435 so as to infer the best answer to the original question posed by actors 410 and, in some circumstances, to reconcile potentially conflicting responses from virtual experts 430, 435. In addition, answers to questions and subquestions may be saved in a memory, e.g., a cache memory, and refreshed at periodic intervals appropriate to the type of data involved, and acceptable data latency requirements.

Multi virtual expert system 400 may be arranged on a network, or they may be configured in a standalone system running in a single personal computer or server, for example. Virtual expert panel manager 420, virtual experts 430, 435, virtual assistants 431, 432, 436, 438, and virtual agents 440-443 may all be considered to be components, and their names serve as a logical distinction of the complexity or abstraction of the questions that they are able to answer. Further, virtual expert panel manager 420 may utilize his own knowledge or set of adaptable system “rules” to determine how one expert's answer relates to another.

For example, a performance expert may indicate that a server has a performance problem, but a change manager may indicate that the server was reinstalled at that time. Virtual expert panel manager 420 may have a rule that says that performance issues in case of a reinstallation are not to be reported, and thus can reconcile what would appear to be conflicting answers provided by virtual experts 430, 435, for example. Based on the number of experts available, virtual expert panel manager 420 can answer more detailed questions, and can use his own knowledge or rules to reconcile various answers received from experts in different aspects of the domain. As in the above example, the user may ask virtual expert panel manager 420 about system performance, and this question is relayed to the performance expert, but other questions are relayed to other experts to qualify the performance answer, e.g., to suppress false alarms, provide answers to poor performance, add extra information, etc.

It should be noted that the iconic representations of virtual expert panel manager 420, virtual experts 430, 435, virtual assistants 431, 432, 436, and 438, and optional virtual agents 440-443 in FIG. 4 are intended to be merely illustrative and non-functional in nature by themselves, and are not representative of any specific product or process such that any copyright, trademark, service mark, or trade dress protection that may be available as source indicia is not implicated or impacted.

Table I below provides a summary listing in hierarchical order of various entities and exemplary functions related to FIG. 4.

TABLE I
MULTI-EXPERT SYSTEM VIRTUAL HIERARCHY

| Entity | Functions |
|---|---|
| Virtual Expert Panel | Answers questions within a specific domain |
| | May include a virtual expert panel manager and a |
| | number of virtual experts each having expert |
| | knowledge within a specific domain |
| Virtual Expert Panel | Receives requests from the actors (users and |
| Manager | systems) |
| | Coordinates and dispatches the activities between |
| | the virtual experts represented in the virtual expert |
| | panel |
| | Infers logical conclusions based on results from the |
| | virtual experts represented in the virtual expert |
| | panel |
| | Passes the combined result to the requester or |
| | instructs the virtual assistants to handle a task |
| | related to the combined result |
| Virtual Expert | Receives requests and instructions from the Virtual |
| | Expert Panel Manager |
| | Infers logical conclusions within a specific domain |
| | based on results from the virtual assistants and one |
| | or more knowledge databases |
| | Coordinates and dispatches the activities between |
| | the virtual assistants |
| | Passes the combined result to the Virtual Expert |
| | Panel Manager |
| Virtual Assistant | Receives requests and instructions from the virtual |
| | expert |
| | Collects information from the users |
| | Coordinates and dispatches the activities between |
| | the virtual agents |
| | Passes the combined result to the virtual expert |
| Virtual Agent | Optionally receives requests and instructions from |
| | the virtual assistant |
| | Collects information from the surrounding |
| | environment |
| | Passes the combined results to the virtual expert |
| | Receives instructions from the virtual assistant on |
| | how to execute a specific task |

Another embodiment of this disclosure is provided in FIGS. 5A and 5B, in which expert system 500 includes various components communicating over network 510, for example. Workstation 520 may be a personal computer or other processor arrangement through which a user may input and output available information through one or more computer interfaces, and through which questions may be asked of one or more experts in one or more domains.

In an optional aspect of an embodiment relating to network administration and/or management functions, for example, computer 530 and database 540 may be used to collect, organize, and/or store information relating to a number of network nodes or elements (e.g., 560, 561, . . . , “56n”) through associated discovery agents (e.g., 550, 551, “55n”) which may run on or be associated with each network node/element. Network information may include, but is not limited to processor loading/utilization, memory usage, or other information that might be useful in evaluating network performance, particularly performance of a large, dynamically changing network environment. Network information may also include associated information relating to the freshness or data latency parameter(s) of one or more data elements stored in database 540. Database 540 may be a configuration management database configured to store network-related information reported by one or more discovery agents 550, 551, “55n” deployed throughout the network.

Processor 570 may be configured to provide particular types of expertise in the form of subexpert systems running therein which rely upon knowledge stored in a particular knowledge database (e.g., 580, 581, and/or 582) directed to one or more domains or subparts of a domain. Processor 570 may be further configured to include program code that implements a reconciliation agent useful for reconciling potentially contradictory or ambiguous information provided by the subexperts implemented in the software running in processor 570. Alternatively, the reconciliation agent may be arranged in workstation 520. The reconciled information or answer may then be made available on network 510 by processor 570, and may be received by workstation 570 through network interface 525 in FIG. 5B, which illustrates an exemplary implementation of workstation 520. Further, memory 575 may be a cache memory which may allow more timely access to stored information than other types of memory. Although computer 530 and processor 570 are shown in FIG. 5A as being separate elements, the functions performed by these components may be combined into one processor/computer. For example, the functions performed by computer 530 may be incorporated into the functionality of processor 570, and database 540 may be operatively connected to processor 570.

As depicted in FIG. 5B, workstation 520 may include processor 521 connected to input/output device(s) 522. Such input/output devices may be conventional devices including keyboard, mouse, printer, etc. Display 523 may also provide a visual output for a user via a graphical user interface supported by input/output device(s) 522 and an operating system running in processor 521. Memory 524 may be a conventional read/write memory coupled to processor 521. Through software code running in processor 521, workstation 520 may interface with either or both computer 530 and processor 570, and their associated databases and memory elements. For example, a user of workstation 520 may pose one or more questions regarding a domain or domains in which an expert system and/or subexperts implemented by software in processor 570 have particular expertise. The query or question from workstation 520 may be provided in the form of a preformatted message and sent via network interface 525 to processor 570 over network 510, for example.

In a related aspect of this embodiment, a computer-implemented system for managing data in a network includes an interface, for example, a computer interface (e.g., network interface 525) implemented in a combination of software and hardware such that computer/workstation 520 may communicate with a database arrangement, e.g., database 540 through computer 530. Database 540 may be a configuration management database having a data structure arranged to store domain or network-related information. The stored data may be stored and/or refreshed depending on the data meeting one or more data latency requirements or conditions, i.e., depending on the “freshness” of the data. The computer interface may also be configured to communicate with an inference engine running in processor 570 that is configured to receive one or more queries regarding the network and to infer one or more query results relating to the queries. The query results inferred by the inference engine may be based at least in part upon network-related information and one or more partial answers obtained from knowledge databases 580, 581, and 582. Further, a reconciliation manager may be implemented by a combination of software and hardware to reconcile any inconsistent query results inferred from the query results obtained by the inference engine and to produce an answer to the one or more queries. The reconciliation function discussed above may be implemented in any one of workstation 520, computer 530, or processor 570.

In a related aspect, the computer interface may be configured to receive user input and to provide an output to the user via input/output module 522 and display 523.

In a further aspect of this embodiment, the queries may be selected from a set of predefined questions relating to the domain, for example, questions relating to a network and its performance. The set of predefined questions may be further decomposed into a number of subquestions in a “divide and conquer” manner. In addition, each of the predefined questions or subquestions may have a data dependency relationship associated with it. In this regard, each of the one or more data dependencies may have a data latency requirement that is related to a data refreshing characteristic of a discovery agent or agents on a network. The discovery agent or agents may report network-related information such that one or more partial answers may be derived or obtained from knowledge database(s) 580, 581, 582, for example. Of course, knowledge related to various domains or subdomains may be stored in only one database.

In a related aspect of this embodiment, cache memory 575 may be configured to store most recent answers to a number of predefined questions as well as any sub-questions that may pertain.

The database arrangement of computer 530 and database 540, for example, may evaluate a likelihood of change of the most recent answers to each of the sub-questions and, based upon an evaluation result, a decision may be made as to whether to use the answers currently in the cache memory or to wait for one or more timely or refreshed answers to be obtained. The acceptability of most recent answers may be determined, at least in part, by the acceptability of the associated data latencies.

In a related aspect of this embodiment, a processor (e.g., in workstation 520, computer 530, or processor 570, depending on the implementation) may be configured to produce a signal to refresh at least a portion of the domain or network-related information in response to an evaluation result that indicates that the freshness of data is unacceptable, i.e., that one or more data latencies is unacceptable.

In the case where network performance is being analyzed, for example, a false alarm condition relating to one or more network performance parameters may be avoided by reconciling potentially conflicting answers or responses.

In a further aspect of this embodiment, knowledge databases 580, 581, and 582 may include a domain-dependent database having information relating to a compilation of best practices relating to the domain, for example, in the network management context, the best practices may be related to database management and performance. Extending this example, the knowledge databases may include a human resources database that may be used to evaluate whether a network condition is abnormal based upon database management rights of users contained in the human resources database. For example, a condition that would otherwise cause an alarm to be raised concerning slow database access times might be suppressed by the system if an authorized user was known or determined to be performing database maintenance or backup. A domain may be related to a specific application or network. For example, as mentioned above, the best practices may be related to database management and performance, but may instead relate to a medical diagnostics application, for example, diagnostics related to sleep disorders.

In another aspect of the embodiment of FIG. 5A, a computer-implemented method of managing a computer network includes receiving a question asked from a list of predefined questions, and decomposing or parsing the question into related subquestions. A determination of the data necessary to answer one or more of the subquestions may be made. A storage device may be checked for necessary data. If a data latency associated with the necessary data is unacceptable, the necessary data may be collected from one or more elements in the network. Further, an answer stored in the cache may be refreshed based upon the updated data. Stored data may be used to answer the subquestions and to obtain one or more partial results that may be stored in cache. An answer to the question may then be inferred from one or more partial results. Likewise, the cache may contain a pre-formulated answer to the query/sub-query being posed (which may have been formulated by a scheduled process running in the background), and the process may check the latency of the data underlying the answer to determine whether the answer was based on acceptably fresh data. If so, the answer can be used; if not, the data gathering and inference process can be run to formulate an answer based on fresh data.

In a related aspect, dependencies of the necessary data may be checked through an interface and dependent data may be refreshed based at least on a data latency parameter of the necessary data.

In a related aspect, answer or data refresh operations for a stored answer or data may be scheduled through an interface based, at least in part, upon a likelihood that a particular data element has changed. In a related aspect, an answer to the question is inferred from the one or more partial results includes reconciling potentially conflicting or ambiguous partial results.

In another aspect of this embodiment, the list of predefined questions relates to a particular domain. For example, the particular domain may relate to medical diagnostics or network management. In a related aspect, receiving the question includes receiving the question through a user interface. In another related aspect, information obtained through a user interface is used to at least partially answer one or more of the subquestions.

Although the system and method represented by FIGS. 5A and 5B may be implemented in a relatively constrained geographic area on a small-scale network, the system and method may also be implemented on a larger geographic basis or over a larger distributed network configuration. For example, knowledge databases and/or discovery agent 550 and associated network node 560 may be separated by a considerable geographic distance from workstation 520, and may even reside in different countries, depending on the nature of the system and its requirements. In addition, the inference engine functionality may also be located at a geographic position that is remote from the interface. Further, the system may be implemented over the internet rather than a dedicated network such as a local area network (LAN) or wide area network (WAN).

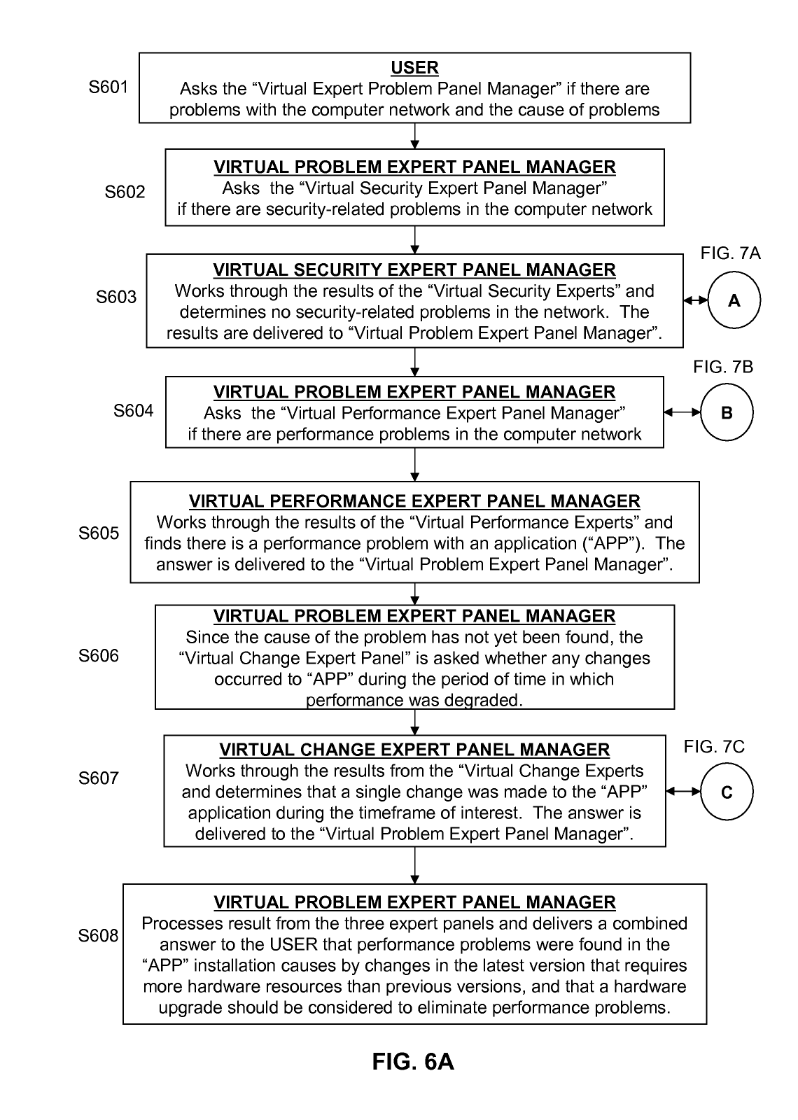

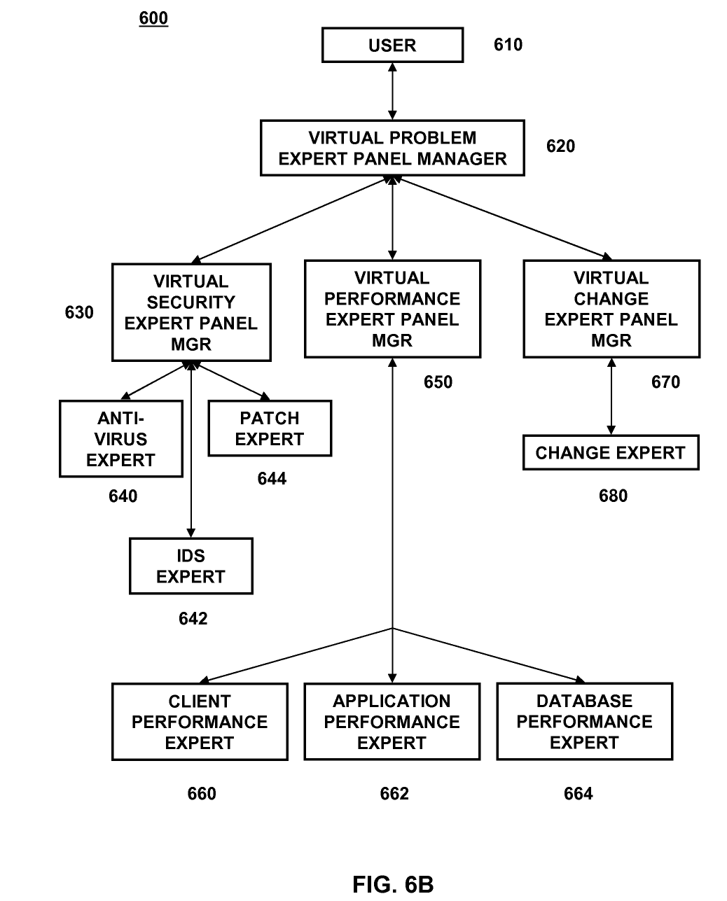

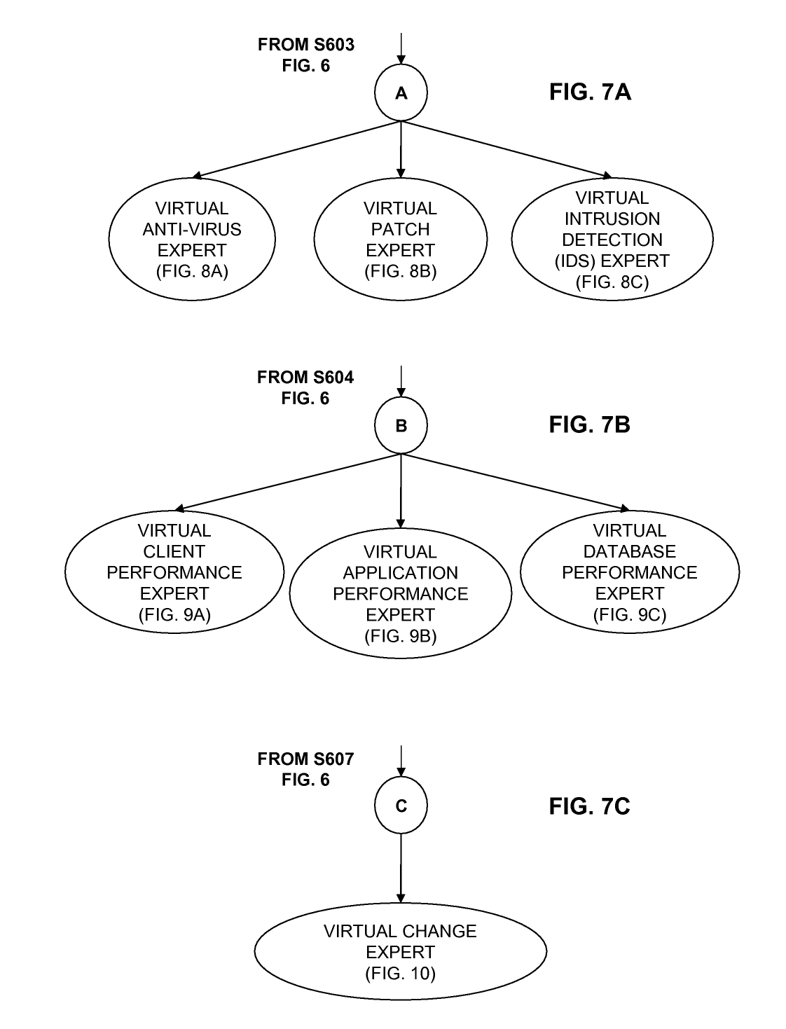

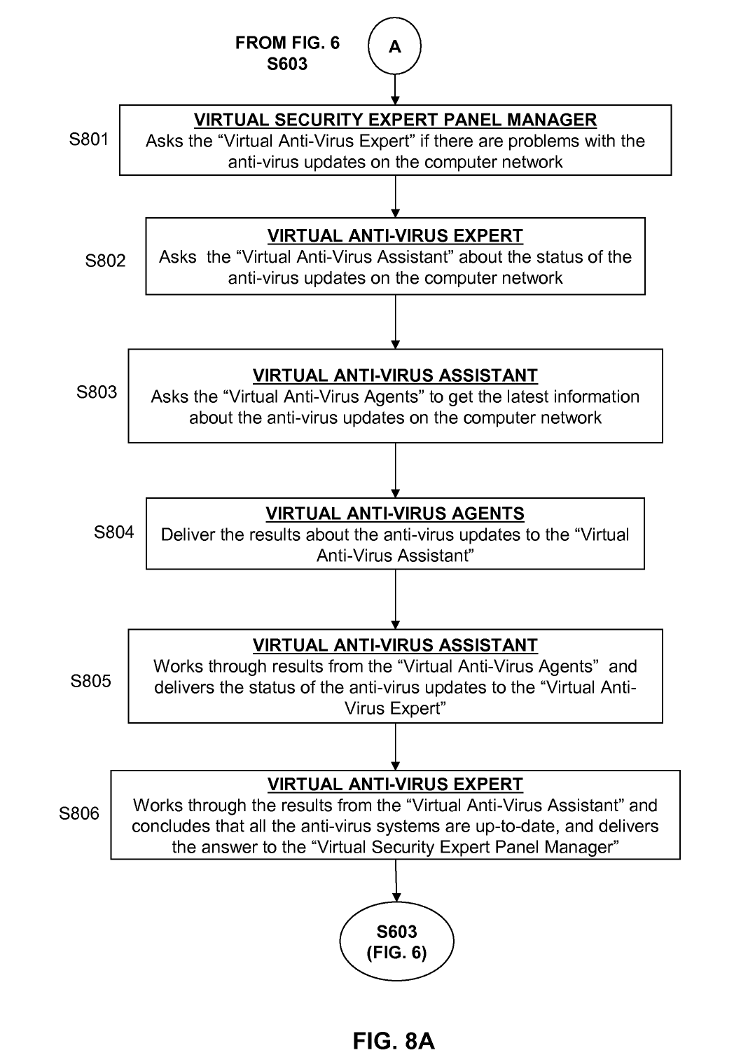

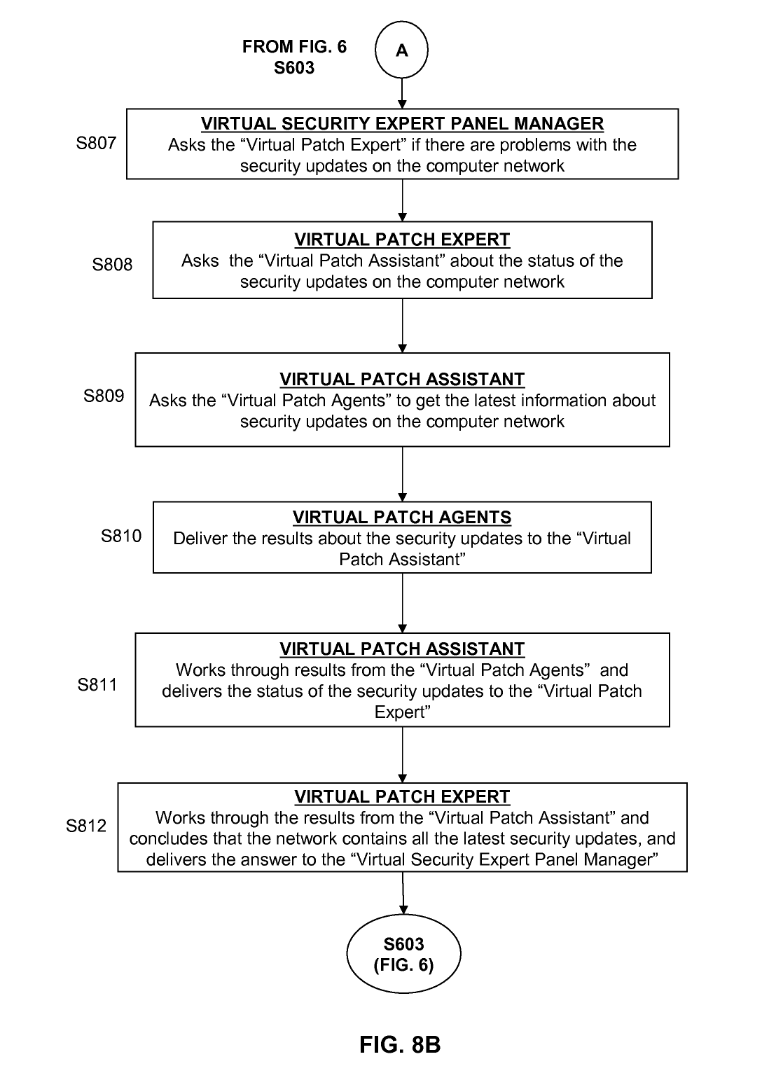

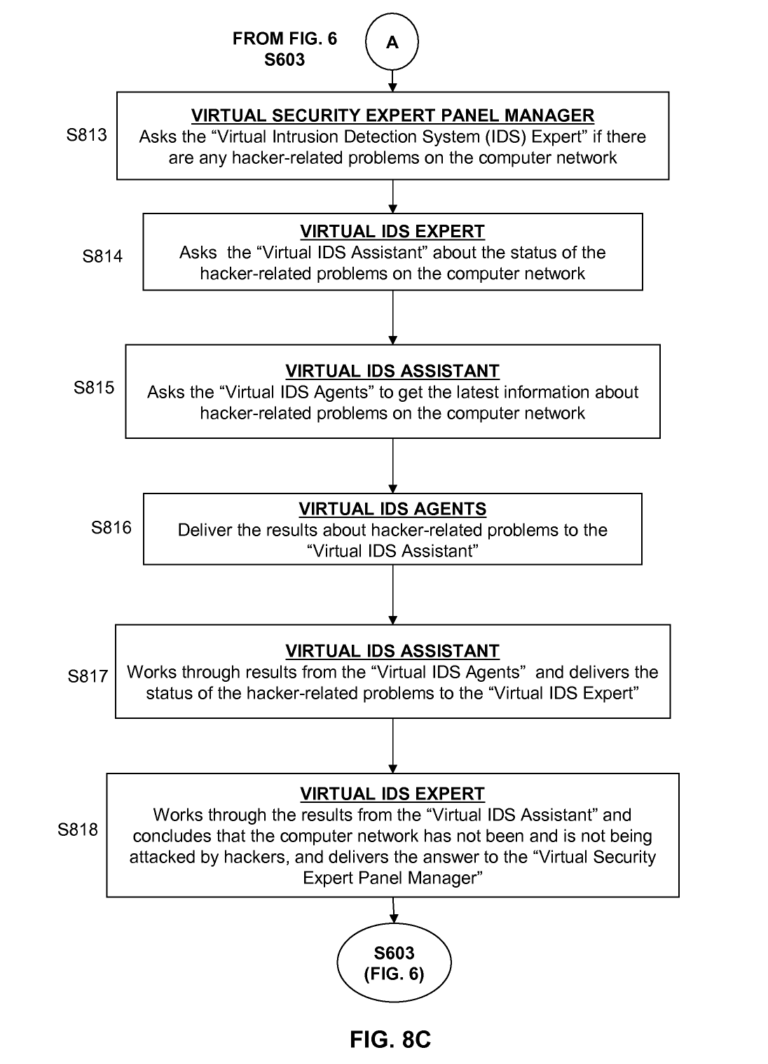

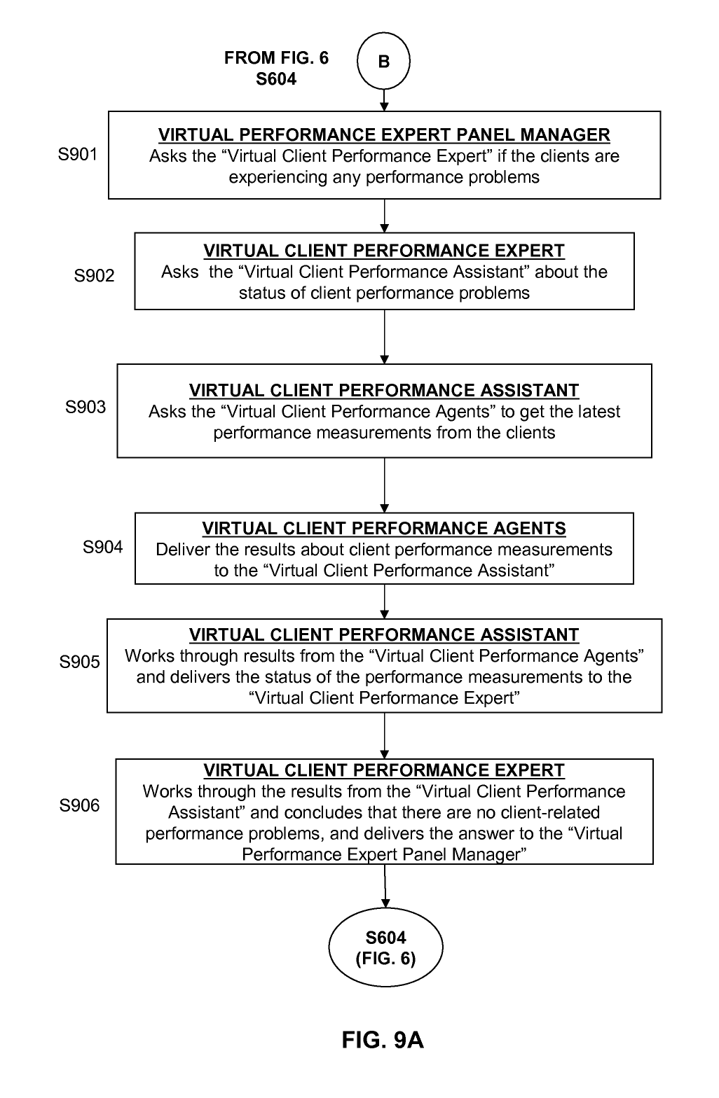

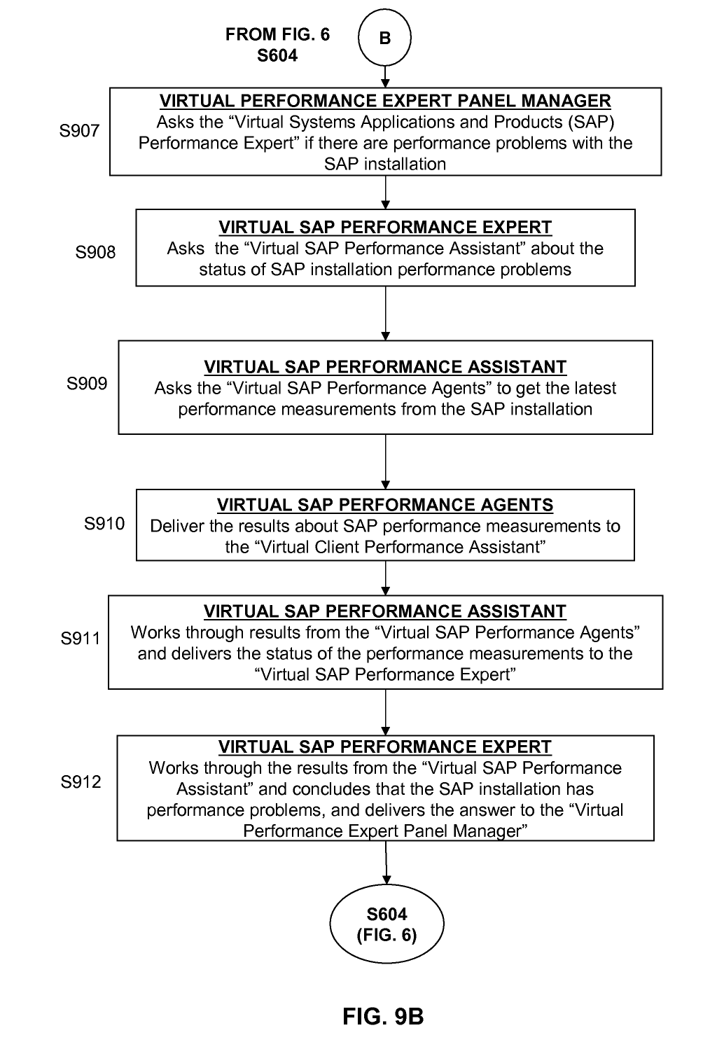

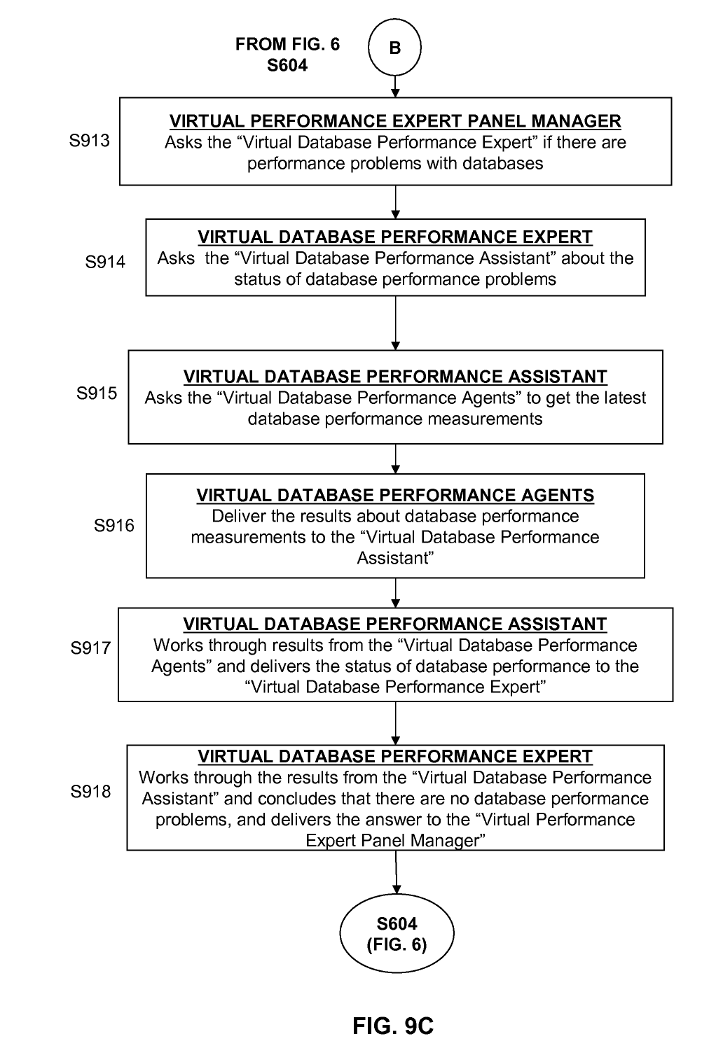

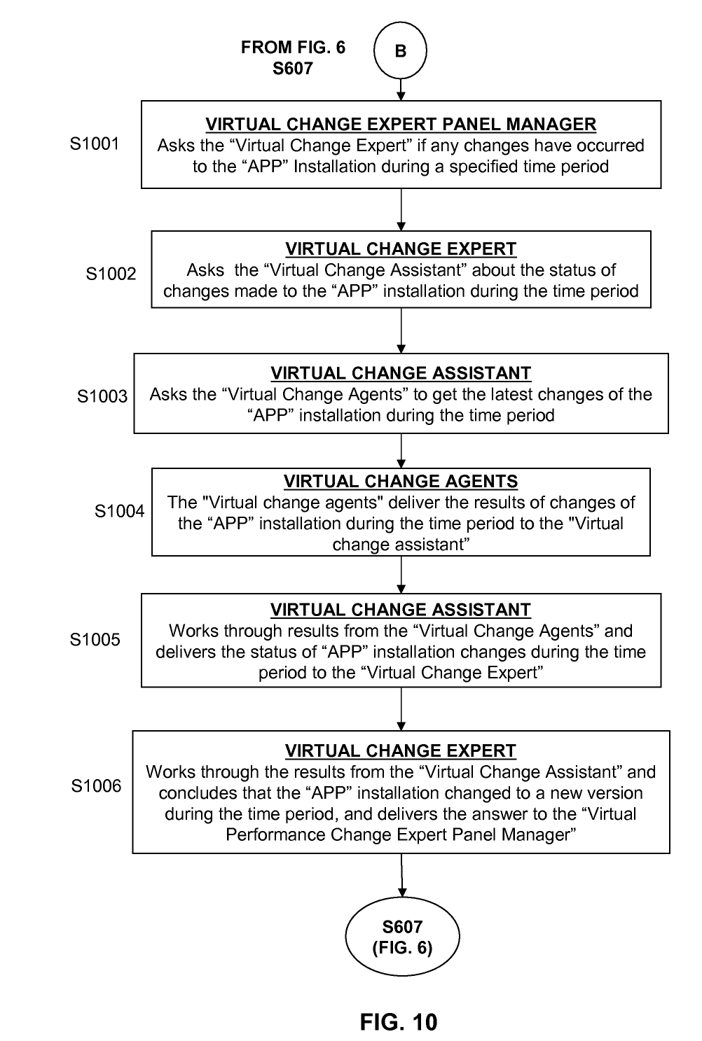

By way of a specific example directed to ascertaining network performance, exemplary embodiments of an expert method and expert system 600 directed to management of a distributed computer network is illustrated in the flowchart of FIG. 6A (and in the flowchart continuation in FIGS. 7A,-7C, 8A-8C, 9A-9C, and 10), and the block diagram of FIG. 6B. In this illustrative example, network performance has unknowingly been degraded due to performance problems associated with an application program (i.e., the “APP” application). In this example, changes to the latest version of the “APP” program required more hardware resources than previous versions, and a hardware upgrade would be necessary to eliminate performance problems. A system and method of this embodiment are useful in reaching this conclusion, as further detailed below with reference to FIGS. 6A and 6B.

For example, at step S601, user 610 of system 600 asks Virtual Expert Problem Panel Manager 620 if there are problems in the computer network, and the cause of any such problems. At step S602, Virtual Problem Expert Panel Manager 620 asks Virtual Security Expert Panel Manager 630 if there are any security-related problems in the computer network. In response, Virtual Security Expert Panel Manager 630 makes inquiries at step S603 (node “A” of FIG. 7A) to Virtual Anti-Virus Expert 640, Virtual Patch Expert 644, and Virtual Intrusion Detection (IDS) Expert 642 as depicted in FIGS. 6B and 7A, and carries out steps that may be considered necessary in FIGS. 8A, 8B, and 8C, depending on the problem being evaluated the. In this example, there are no security-related problems in the computer network. Details of the operation of these various security experts with respect to this specific example may be understood with reference to these figures.

Then, at step S604, Virtual Performance Expert Panel Manager 650 makes inquiries at step S604 (node “B” of FIG. 7B) to Virtual Client Performance Expert 660, Virtual Application Performance Expert 662, and Virtual Database Performance Expert 664 as depicted in FIGS. 6B and 7B, and FIGS. 9A, 9B, and 9C. Details of the operation of these various performance experts with respect to this specific example may be understood with reference to these figures. Results from these Virtual Performance Experts 660, 662, 664 are evaluated and, in this example, these particular inquiries help determine that there is a performance problem with the “APP” application program, although the cause of the problem has not yet been identified. This result is delivered to Virtual Problem Expert Panel Manager 620 who then, at step S606, asks Virtual Change Expert Panel 670 whether any changes occurred to the “APP” program during the period of time in which performance was observed to be degraded.

Virtual Change Expert Panel Manager 670 makes inquiries at step S607 (node “C” of FIG. 7C) of Virtual Change Expert 680 as depicted in FIGS. 6B and 10. Virtual Change Expert 680 ascertains that a single change was made to the “APP” application program during the timeframe of interest. In response, the Virtual Problem Expert Panel Manager 620 processes the results from the three expert panels, and delivers a combine answer to User 610 to the effect that performance problems were found in the “APP” installation caused by changes in the latest version that require more hardware resources than previous versions, and that a hardware upgrade should be considered to eliminate performance problems.

In another embodiment of this disclosure, an article of manufacture includes a machine-readable medium containing computer-executable instructions. When executed by a processor or computer, the instructions may cause an expert system to be installed in the processor. The expert system may be configured to carry out various functions including receiving a question asked from a list of predefined questions; decomposing the question into subquestions; determining data necessary to answer one or more of the subquestions; checking a storage device for the necessary data and, if a data latency associated with the necessary data is unacceptable, collecting the necessary data from one or more elements in the network and refreshing the stored data; using collected data to answer the subquestions and to obtain one or more partial results; and inferring an answer to the question from the one or more partial results. In a related aspect, the expert system may be further configured to carry out the function of reconciling potentially conflicting or ambiguous partial results.

The above description is intended to describe various exemplary embodiments and aspects of this disclosure, and is not intended to limit the spirit and scope of the following claims.

What is claimed is:

1. A method of determining an answer to a query, comprising:
transmitting a query or a series of sub-queries relating thereto to a plurality of sub-expert systems, each sub-expert system comprising an associated inference engine and an associated knowledge database;
receiving, with an expert system comprising an inference engine and a knowledge database, a sub-answer to the query or sub-query from each sub-expert system which has been inferred by the inference engine thereof based upon knowledge in the associated knowledge database thereof;
with the expert system, using the inference engine thereof to infer an answer to the query based upon knowledge in the associated knowledge database and the sub-answers received from the sub-expert systems; and
transmitting the answer.

2. The method of claim 1, further comprising using the expert system to reconcile one or more inconsistent sub-answers provided by two or more sub-expert systems.

3. The method of claim 1, further comprising, with each sub-expert system, inferring a sub-answer to the query or sub-query transmitted thereto with the inference engine thereof based upon the knowledge in the associated knowledge database.

4. The method of claim 1, further comprising using an interface configured to receive user input for transmission to the expert system, and to transmit the answer to the user.

5. The method of claim 1, further comprising selecting the query or the series of sub-queries from a set of predefined questions relating to a domain.

6. The method of claim 5, wherein one or more of the predefined questions comprise a plurality of subquestions related thereto.

7. The method of claim 5, further comprising associating one or more data dependencies with each of the predefined questions.

8. The method of claim 7, wherein each of the one or more data dependencies has an associated data latency or freshness requirement, said associated data latency or freshness requirement being related to a data refreshing characteristic of at least one of a plurality of discovery agents on the network.

9. The method of claim 1, wherein said using the inference engine thereof to infer an answer to the query comprises applying a weighting function to the sub-answers received from the sub-expert systems.

10. The method of claim 5, further comprising caching most recent answers to the set of predefined questions and sub-questions pertaining thereto.

11. The method of claim 10, further comprising evaluating a likelihood of change of the most recent answers to each of the set of predefined questions and sub-questions and, based upon an evaluation result, deciding whether to use the most recent answers currently cached in a memory or to wait for one or more answers or sub-answers to be refreshed.

12. The method of claim 10, further comprising determining acceptability of one or more of the most recent answers, at least in part, by the acceptability of one or more data latencies associated therewith.

13. The method of claim 7, further comprising producing a signal to refresh at least a portion of domain-related information in response to an evaluation result that indicates that said one or more data latencies is unacceptable.

14. The method of claim 1, wherein the expert system has expertise related to computer-network performance, the method further comprising avoiding a false-alarm condition from being generated relating to one or more network performance parameters by reconciling potentially conflicting sub-answers.

15. The method of claim 1, wherein the associated knowledge database comprises a domain-dependent database comprising at least a compilation of best practices relating to a domain.

16. The method of claim 15, wherein the best practices are related to database management and performance.

17. The method of claim 16, wherein the associated knowledge database further comprises a human resources database, said inference engine using said human resources database to evaluate whether a network condition is abnormal based upon database management rights of one or more users contained in the human resources database.

18. The method of claim 1, wherein the answer is transmitted over the internet.

19. An arrangement of components, comprising:
an interface through which a domain-related question is communicated to an expert component having expertise in the domain;
plural sub-experts in communication with the expert component, said one or more sub-experts each having expertise in different aspects of the domain;
one or more data storage elements, wherein each of the data storage elements are interfaced with at least one of the plural sub-experts,
wherein the plural sub-experts are configured to use knowledge contained in said one or more data storage components to answer one or more subquestions pertaining to the domain-related question,
wherein the expert component is configured to evaluate the answers to the one or more subquestions and to answer the domain-related question.

20. The arrangement of claim 19, further comprising one or more discovery agents associated with respective one or more physical devices, wherein each of the one or more discovery agents are in data communication with at least one of the one or more data storage components.

21. The arrangement of claim 20, wherein the one or more discovery agents follow associated data refresh schedules that enable acceptable data latency for status information relating to the one or more physical devices stored in at least one of the one or more data storage components.

22. The arrangement of claim 19, wherein the domain-related question is selected from a plurality of predefined questions relating to the domain.

23. The arrangement of claim 22, wherein most recent answers to each of the plurality of predefined questions are stored in a cache.

24. The arrangement of claim 22, wherein at least one predefined question comprises a plurality of predefined sub-questions relating to the domain.

25. The arrangement of claim 19, wherein the interface is configured to allow a user to select one of a plurality of predefined questions to be answered.

26. A computer-implemented multi virtual expert system having expertise in a domain, the system comprising:
a user interface;
an expert manager configured to receive a user question related to the domain via the user interface and to identify one or more subquestions relating to the user question;
a plurality of experts each capable of receiving and evaluating an answer to at least one of the one or more subquestions and reporting the answer to the expert manager;
wherein the expert manager is configured to evaluate answers to the subquestions and reconcile any inconsistencies between the answers to the subquestions to form the answer to the user question.

27. The system of claim 26, further comprising a plurality of virtual assistants each configured to provide an answer to at least one of the one or more subquestions to an associated expert.

28. The system of claim 26, further comprising a plurality of collection agents, wherein each collection agent is associated with at least one of the plurality of experts, each of the plurality of collection agents being configured to collect data requested by an associated expert and to report collected data to the associated expert, wherein the associated expert uses the collected data to answer one or more subquestions.

29. The system of claim 28, wherein each of the plurality of collection agents is configured to store the collected data in a cache memory and wherein the associated expert evaluates a data latency parameter related to the collected data.

30. The system of claim 28, wherein the plurality of collection agents are configured to push changed data to a cache memory.

31. The system of claim 28, wherein associated data latency requirements are imposed on the collected data based, at least in part, upon a likelihood of change of a particular piece of data.

32. The system of claim 29, wherein, in response to the evaluation of the latency parameter, an associated collection agent collects and stores refreshed data in the cache memory.

33. The system of claim 26, wherein the user question is selected from a plurality of predefined questions having various data dependencies associated therewith.

34. The system of claim 26, wherein the expert manager answers the user question using data stored in a cache memory without involvement of a collection agent.

35. The system of claim 26, wherein the expert manager compares partial conclusions received from the plurality of experts.

36. The system of claim 26, wherein the domain comprises medical diagnosis.

37. The system of claim 36, wherein the domain comprises the diagnosis of sleep disorders.

38. The system of claim 26, wherein the domain comprises database management.

39. The system of claim 26, further comprising a communications interface through which the system may communicate over a network.

40. A method for determining an answer to a query, comprising:
inferring a pre-formulated answer to each of a plurality of pre-defined queries using an expert system comprising an inference engine and a knowledge database, the expert system being coupled to a network comprising network nodes and data elements relating to the nodes, wherein the inference engine infers each answer based on knowledge in the knowledge database and one or more data elements relating to the associated queries;
storing the pre-formulated answers in a memory;
receiving, from a user, a request to provide an answer to one of the pre-defined queries;
checking a data freshness parameter for at least one of the data elements relating to the requested query; and
(a) if each checked data freshness parameter is acceptable, providing the pre-formulated answer in the memory to the user in response to the request;
(b) if any checked data freshness parameter is unacceptable, then
(i) inferring a new answer to the requested query using the expert system, wherein the new answer is based on the knowledge in the knowledge database and the one or more data elements relating to the requested query; and
(ii) providing the new answer to the user in response to the request.

41. The method of claim 40, wherein one or more of the plurality of pre-defined queries is decomposed into a plurality of subquestions.

42. The method of claim 41, further comprising determining, by the expert system, data necessary to answer one or more of the plurality of subquestions.

43. The method of claim 40, further comprising, if a checked data freshness parameter associated with data necessary is unacceptable, collecting the necessary data from the one or more data elements relating to the requested query and refreshing one or more pre-formulated answers in the memory.

44. The method of claim 40, further comprising, through an interface, checking dependencies of data necessary to provide an answer to the user, and refreshing dependent data based at least on a data freshness parameter of the necessary data.

45. The method of claim 40, further comprising scheduling data refresh operations for answers stored in the memory based, at least in part, upon a likelihood that a particular data element has changed.

46. The method of claim 40, wherein said inferring a new answer to the requested query comprises reconciling potentially conflicting or ambiguous partial answers.

47. The method of claim 40, wherein the pre-formulated answers relate to a particular domain.

48. The method of claim 47, wherein the particular domain comprises medical diagnostics.

49. The method of claim 47, wherein the particular domain comprises network management.

50. The method of claim 40, further comprising using information obtained from the user to revise one or more pre-formulated answers and to provide a revised answer to the user.

51. A computer-implemented method of using expert knowledge to provide an answer to a question related to a domain, the method comprising:
posing the question to a panel of experts;
decomposing the question into a plurality of subquestions related to various aspects of the domain;
answering each of the subquestions with a partial answer obtained from one or more relevant experts having access to one or more associated knowledge databases;
evaluating each of the partial answers;
reconciling any inconsistencies or ambiguity between any of the partial answers; and
inferring the answer based upon said reconciling.

52. The method of claim 51, wherein the domain relates to computer network management and administration.

53. The method of claim 51, wherein the domain relates to medical diagnosis.

54. The method of claim 51, wherein said posing the question comprises posing one question selected from a set of predefined questions to the panel of experts.

55. The method of claim 54, wherein one or more of the predefined questions have predefined subquestions associated therewith.

56. The method of claim 54, wherein partial answers associated with each of the predefined questions are stored in a cache memory.

57. The method of claim 51, further comprising collecting data that may change over time and evaluating data latency characteristics associated with the collected data.

58. The method of claim 57, further comprising refreshing collected data in response to the evaluation of a particular data latency characteristic.

59. The method of claim 58, wherein refreshed data is stored in a cache memory.

60. An article of manufacture comprising a machine-readable medium containing computer-executable instructions therein which, when executed by a processor, cause an expert system to be installed in the processor, said expert system being configured to carry out the functions of:
receiving a question asked from a list of predefined questions;
decomposing the question into subquestions;
determining data necessary to answer one or more of the subquestions;
using the necessary data to answer the subquestions and to obtain one or more partial results;
reconciling any inconsistencies between the one or more partial results; and
inferring an answer to the question based upon said reconciling.

61. The article of manufacture of claim 60, wherein the expert system is further configured to check a data latency related to the necessary data and, if a data latency associated with the necessary data is unacceptable, collecting the necessary data from one or more elements and refreshing an answer in a cache.
